(19) United States
(12) Patent Application Publication
(10) Pub. No.: US 2016/0116960 A1
(43) Pub. Date: Apr. 28, 2016

(54) POWER MANAGEMENT USING EXTERNAL SENSORS AND DATA

(71) Applicant: ATI Technologies ULC, Markham (CA)

(72) Inventors: Lawrence Kwak, Richmond Hill (CA); Wayne C. Louie, Port Perry (CA)

(21) Appl. No.: 14/523,542

(22) Filed: Oct. 24, 2014

(51) Int. Cl. G06F 1/32

(52) U.S. Cl. CPC G06F 1/3206; G06F 1/3231

(57) ABSTRACT

A method of managing power state transitions for a computing system based on the proximity of a user may include determining a location of a mobile device, determining a distance between the location of the mobile device and a location of a computing system to determine whether the mobile device is located within a first threshold distance from the computing system, and in response to determining that the mobile device is located within the first threshold distance from the computing system, transitioning the computing system from a first power state to a second power state.

### TECHNICAL FIELD

This disclosure relates to the field of power management and, in particular, to power management in a computing system.

### BACKGROUND

Many modern computing systems include power management functionality for reducing the overall amount of power consumed by the computing system. Power management may be implemented using software or hardware in the computing system capable of placing the computing system in different power states. For example, a power management scheme may cause the computing system to operate in the power state having the lowest power demand that also does not interfere with the desired use of the computing system.

The Advanced Configuration and Power Interface (ACPI) specification provides an open standard for implementing power management in a computing system. ACPI defines several power states in which a computing system may operate. In the G0(S0) state, a display of the computing system may be turned off while background tasks are still running. The ACPI G1 “sleeping” state is subdivided into four states, S1 through S4. Often used are the S3 state, referred to as Standby, Sleep, or Suspend to RAM (STR) and the S4 state, referred to as Hibernation or Suspend to Disk. The S3 state allows the computing system's random access memory (RAM) to remain powered, and the S4 state provides for all content of the main memory to be saved to non-volatile memory such as a hard drive before powering down the computing system.

### BRIEF DESCRIPTION OF THE DRAWINGS

The present disclosure is illustrated by way of example, and not by way of limitation, in the figures of the accompanying drawings.

FIG. 1 illustrates a computing system and a mobile device, according to an embodiment.

FIG. 2A illustrates threshold distances between the mobile device and computing system, according to an embodiment.

FIG. 2B illustrates threshold distances between the mobile device and computing system, according to an embodiment.

FIG. 3 is a flow diagram illustrating a power management process, according to an embodiment.

### DETAILED DESCRIPTION

The following description sets forth numerous specific details such as examples of specific systems, components, methods, and so forth, in order to provide a good understanding of the embodiments. It will be apparent to one skilled in the art, however, that at least some embodiments may be practiced without these specific details. In other instances, well-known components or methods are not described in detail or are presented in a simple block diagram format in order to avoid unnecessarily obscuring the embodiments. Thus, the specific details set forth are merely exemplary. Particular implementations may vary from these exemplary details and still be contemplated to be within the spirit and scope of the embodiments.

In one embodiment, a computing system implements a power management scheme that changes the power state of the computing system based on external sensors and data indicating the proximity of a user. For example, such a computing system includes a proximity detection module operable to remotely track the location of a user via a mobile device carried by a user so that the power state of the computing system may be changed when the user approaches within a threshold distance of the computing system. As described herein, transitioning the power state of the computing system can include transitioning the power state of any or all of the devices that are part of the computing system, or that are attached to or controlled by the computing system.

In one embodiment, the proximity detection module determines whether the user's mobile device is within any of multiple threshold distances from the computing system and may transition the computing system through multiple successive power states accordingly. For example, the proximity detection module may cause the computing system to transition from a S4 hibernate state to a S3 standby state, then to a G0(S0) working state as the user's mobile device crosses successive thresholds while approaching nearer to the computing system, where each threshold crossing corresponds to a power state transition.

Additionally, some embodiments may determine the proximity of the user using one or more secondary proximity detection devices, such as a camera, microphone, or other peripheral of the computing system. In one embodiment, the proximity detection module switches from tracking the user's mobile device to monitoring a camera and microphone attached to the computing system to additionally change the power state based on the movement, orientation, or sound level produced by the user. In such an embodiment, the camera detects that a user is near the computing system by detecting motion, while the microphone detects an increase in the sound level caused by the user. With the use of face-tracking software, the camera also determines when the user is facing the computing system and turns on the display accordingly.

In alternative embodiments, the proximity detection module may determine the proximity of the user by other methods; for example, an increase in the strength of a wireless signal produced by the user's mobile device above a certain threshold may indicate that the user is approaching. The user's proximity may also be inferred if the user's mobile device connects to a wireless network having a known location.

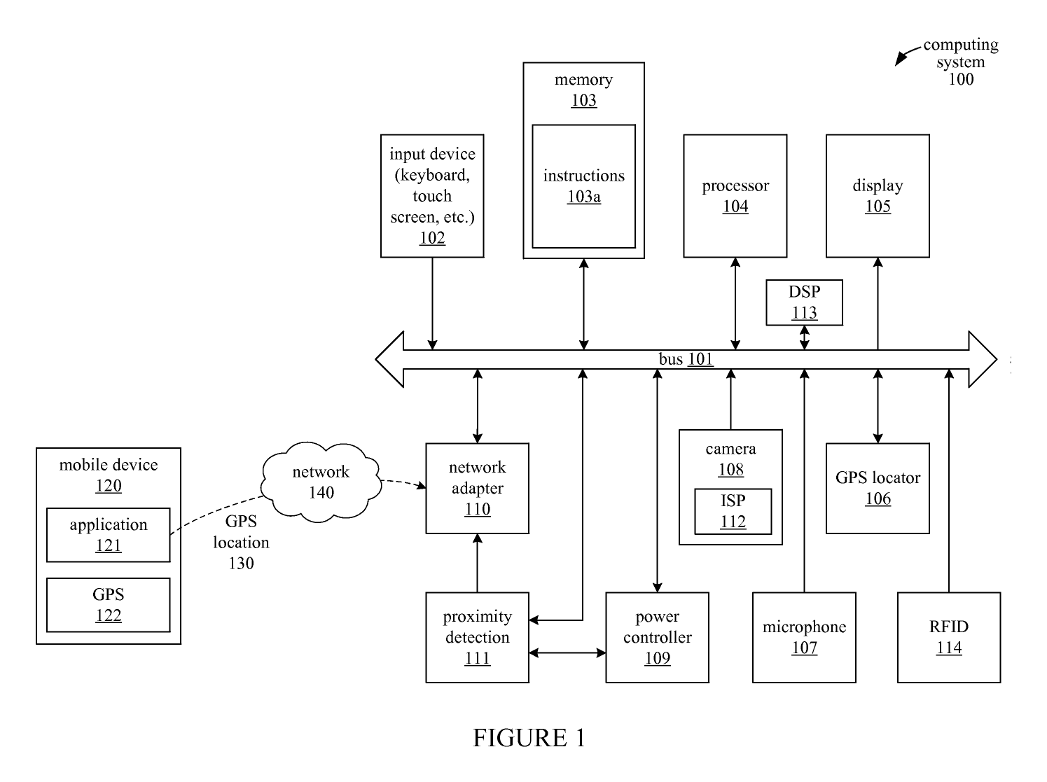

FIG. 1 illustrates an embodiment of a computing system 100 which may implement a power management scheme that changes the power state of the computing system 100 based on external sensors and data indicating the proximity of a user. In general, the computing system 100 may be embodied as any of a number of different types of devices, including but not limited to a laptop or desktop computer, mobile phone, server, etc. The computing system 100 includes a number of components 102-110 that can communicate with each other through a bus 101. In computing system 100, each of the components 102-110 is capable of communicating with any of the other components 102-110 either directly through the bus 101, or via one or more of the other components 102-110. The components 101-110 in computing system 100 are contained within a single physical casing, such as a laptop or desktop chassis, or a mobile phone casing. In alternative embodiments, some of the components of computing system 100 may be embodied as peripheral devices such that the entire computing system 100 does not reside within a single physical casing.

Computing system 100 includes a processor 104 that is configured to receive and execute instructions 103a that are stored in the memory subsystem 103. Memory subsystem 103 includes memory devices used by the computing system 100, such as random-access memory (RAM) modules, read-only memory (ROM) modules, hard disks, and other non-transitory computer-readable media.

The computing system 100 also includes a power controller 109, which may include hardware, software, and/or firmware for allowing the computing system 100 to operate in different power states. In one embodiment, different power states represent different combinations of components and/or peripheral devices of computing system 100 that are in the powered state or are being operated at different levels of power consumption. In one embodiment, the power controller 109 implements multiple power states as defined in the ACPI specification.

The computing system 100 also includes user interface devices for receiving information from or providing information to a user. Specifically, the computing system 100 includes an input device 102, such as a keyboard, mouse, touch-screen, or other device for receiving information from the user. The computing system 100 displays information to the user via a display 105, such as a monitor, light-emitting diode (LED) display, liquid crystal display, or other output device.

Computing system 100 additionally includes a number of components that may be used for location detection. The global positioning system (GPS) locator 106 is a dedicated location detection module that can detect its own location based on received GPS signals. Other components, such as network adapter 110, may be primarily used for transmitting and receiving data over a wired or wireless network, but are also capable of detecting location.

For example, a network adapter 110 having a physical cable connection may be used for detecting its own location by identifying other hardware devices in a network topology to which it is physically connected. Detection of a location based on the network topology could be performed by software running on the processor 104 based on information provided by the network adapter 110. When the identified hardware devices have known geographic locations, the geographic location of the network adapter 110, and therefore the computing system 100, can be determined.

A wireless network adapter 110 is capable of detecting location by triangulation using signals received from transmitters at known locations, such as cell towers or wireless routers. A wireless network adapter 110 may also detect location based on other characteristics of received signals, such as signal strengths, or by network topology of connected wireless network hardware. In one embodiment, the wireless network adapter may be a Wi-Fi network adapter, a Bluetooth or Bluetooth low energy (LE) device, or may implement some other wireless communication technology, such as active or passive Near-Field Communications (NFC) technology. The presence of a Bluetooth or NFC connection with a user's mobile device 120 indicates that the mobile device 120 is within a distance from the computing system 100 that corresponds to the range of the Bluetooth or NFC device.

The computing system 100 is coupled with a proximity detection module 111. The proximity detection module 111 has an input that is coupled with the network adapter 110 of the computing system 100, and is also coupled with the power controller 109 of the computing system 100. In one embodiment, the proximity detection module 111 is enclosed within the same physical housing as the computing system 100; alternatively, the proximity detection module 111 may be located outside of a housing of the computing system 100. In one embodiment, the proximity detection module 111 may be integrated with the power controller 109 or another component of the computing system 100. The proximity detection module 111 may be implemented using hardware, firmware, software, or a combination of hardware, firmware, and/or software.

The proximity detection module 111 receives from the mobile device 120 a global positioning system (GPS) location 130 of the mobile device 120. The mobile device 120 includes a GPS locator 122 for determining the location of the mobile device 120 based on received GPS signals. A software application 121 executed on the mobile device 120 receives the GPS location 130 of the mobile device 120 from the GPS locator 122 and transmits the location 130 over a network 140 to the computing system 100. GPS location 130 is received at the network adapter 110 of the computing system 100 and is ultimately received at an input of the proximity detection module 111.

In one embodiment, the proximity detection module 111, having received the GPS location 130 of the mobile device 120, determines a distance between the location 130 of the mobile device 120 and a location of the computing system 100. The location of the computing system 100 may be determined by a GPS locator 106 of the computing system 100, calculated based on network topology (e.g., based on known locations of connected network hardware), or acquired by manual user entry or other methods for locating the computing system 100. In one embodiment, the location of the computing system 100 may be determined by a GPS locator 122 of the mobile device 120 when the mobile device 120 is determined to be near the computing system 100. For example, the application 121 of the mobile device 120 may allow the user to save a current location of the mobile device 120 as the location of the computing system 100. In one embodiment, the computing system 100 may detect that the mobile device 120 is nearby, using network connectivity or sensors, and may automatically save the GPS location 130 of the mobile device 120 as its own location.

The proximity detection module 111, having determined the distance between the mobile device 120 and the computing system 100, then determines whether the mobile device 120 is located within a threshold distance from the computing system 100 by comparing the distance between the mobile device 120 and the computing system 100 with a predetermined threshold distance. The mobile device 120 is located within the threshold if the distance between the computing system 100 and the mobile device 120 is less than the threshold distance. In one embodiment, the threshold distance is a radius that is the same regardless of the direction of the mobile device 120 relative to the computing system 100. Alternatively, the threshold distance may be varied depending on the direction to create a virtual boundary having an arbitrary shape.

In one embodiment, the threshold may be learned based on the transition time for the computing system 100 to transition from one power state to another. The threshold may be set to a distance such that the expected travel time of the user between the threshold and the computing system 100 is substantially equal to or greater than the power state transition time of the computing system 100, so that the power state transition can be completed just prior to the user's arrival at the computing system 100. The threshold distance in such an embodiment may be initially learned or refined based on the average speed or travel time of the user as the user approaches the computing system 100 on the same or separate occasions.

In one embodiment, the threshold distances may be varied depending on the current power state of the computing system 100 or the direction of travel of the mobile device 120 so that the power states transitions are hysteretic. Generally, a power state transition from a first power state to a second power state may result from crossing one threshold, while the transition from the second power state back to the first power state results from crossing, in an opposite direction, a different threshold that is farther from the computing system 100.

The proximity detection module 111 is additionally connected to the power controller 109 of the computing system 100, and is capable of communicating with the power controller 109 in order to cause the power controller 109 to change the power state in which the computing system 100 is operating. Thus, in response to determining that that mobile device 120 is located within the threshold distance, the proximity detection module via the power controller 109 causes the computing system 100 to transition from a first power state to a second power state. For example, a proximity detection module according to one embodiment may cause a computing system 100 to transition from an ACPI S4 hibernate power state to an ACPI S3 suspend power state when the mobile device 120 approaches within a threshold distance of 400 meters of the computing system 100.

In one embodiment, the proximity detection module 111 supports different power state transitions for each of multiple thresholds, and may determine whether the mobile device 120 is within any of the multiple thresholds by calculating the distance (and optionally, the direction) between the mobile device 120 and computing system 100, as previously described. For example, the proximity detection module 111 may cause the computing system 100 to transition from a first power state to a second power state in response to determining that the mobile device 120 is located within a first threshold distance, then cause the computing system 100 to transition from the second power state to a third power state in response to determining that the mobile device 120 is also located within a second threshold distance from the computing system 100. Continuing the previous example, after the computing system 100 has been transitioned to the ACPI S3 standby power state, the proximity detection module 111 may transition the computing system 100 from the S3 standby state to an ACPI G0(S0) working power state when the mobile device 120 approaches within a second threshold distance of 100 meters from the computing system 100.

In addition to the GPS tracking of the mobile device 120 the computing system 100 also includes secondary proximity detection devices that may be used to detect the presence of a user. In particular, computing system 100 includes a camera 108, a microphone 107, a radio frequency identification (RFID) module 114, and a network adapter 110 which may detect the presence of a user in close physical proximity to the computing system 100 without the user physically contacting the computing system. As illustrated in FIG. 1, the camera 108, microphone 107, radio frequency identification (RFID) module 114, and network adapter 110 are coupled to communicate with the proximity detection module 111 through the system bus 101 of the computing system 100.

In response to detecting that the mobile device 120 is located within one of the multiple threshold distances from the computing system 100, the proximity detection module 111 activates one or more of the secondary proximity detection devices, allowing the activated secondary proximity detection devices to collect data or otherwise sense the environment surrounding the computing system 100. For example, the proximity detection module 111 may, in response to detecting that the mobile device 120 is within 100 meters of the computing system 100, transition the computing system 100 from the S3 standby state to the G0(S0) working state, and additionally activate the camera 108 and microphone 107. When activated, the camera 108 begins collecting and processing image data to detect the motion of a user near the computing system 100, while the microphone 107 collects and processes sound data to detect noise generated by the user. For the camera 108, the presence of the user is detected when the amount of motion between sequentially captured images exceeds a predetermined image motion threshold. The camera 108 can also be used to recognize gestures performed by the user, or specific image patterns such as a Quick Response (QR) code or bar code on a badge or card carried by the user. In one embodiment, the camera 108 can also detect the proximity of a user based on a light signature; for example, the camera 108 may detect a threshold level of infrared (IR) energy emitted from the body of the user. For the microphone 107, the presence of the user is detected when the detected sound level exceeds a predetermined noise threshold. The microphone 107 can also be used to detect the proximity of a user along with the identity of the user or a command given by the user based on speech or other sound patterns, such as whistles, claps, or other sounds.

The RFID module 114 may also be activated in order to detect the proximity of a user based on detecting the proximity of an RFID tag or transponder carried by the user. For example, an identification badge or card carried by the user may contain an RFID tag that can be detected by the RFID module 114 when the RFID tag is within a certain distance from the RFID module 114. Alternative embodiments may utilize some Far Field Communication technology other than RFID. In one embodiment, the network adapter 110 may represent a Bluetooth or Bluetooth low energy (LE) module, Near Field Communication (NFC) module, or other communications module that is activated to detect the proximity of a user based on establishing communication with the mobile device 120 of the user.

In one embodiment, when the presence of a user is detected near the computing system 100 by one or more of the secondary proximity detection devices, the proximity detection module 111 may again transition the computing system 100 between power states. This may entail transitioning power states for a part of computing system 100, or for a peripheral device of computing system 100. For example, a computing system 100 operating in the G0(S0) working power state with the display powered off may be transitioned to a working power state with the display powered on. In other words, the proximity detection module 111 may power on the display 105 of the computing system 100 in response to one or more of the secondary proximity detection devices detecting the presence of the user.

In alternative embodiments, the proximity detection module 111 may transition the computing system 100 between different ACPI power states in response to the detection of a user near the computing system 100 by one or more of the secondary proximity detection devices. In such an embodiment, power may be supplied to a portion of the computing system 100 sufficient for maintaining operation of the secondary proximity detection devices even while the remainder of the computing system is in a low power state, such as a hibernate or sleep state.

The computing system 100 includes processing elements in addition to processor 104, such as a digital signal processor (DSP) 113 for processing audio from the microphone 107 and an image signal processor (ISP) 112 in the camera 108. The computing system 100 may then be configured so that calculations for some of the above-described proximity detection and power state transition functions are performed by the ISP 112 and/or the DSP 113 while the processor 104 and other components of the computing system 100 remain in the S3 or S4 power state. Thus, less power is consumed because power is supplied to one or more of the additional processing elements 112 and 113 for performing the proximity detection and power state transition functions while the main processor 104 remains in a lower power state.

In alternative embodiments, the proximity detection module 111 may, in response to detecting the proximity of a user, power up one or more other peripheral devices or devices which are part of computing system 100, such as hard drives or communication devices, for example. In alternative embodiments, the powering up of such devices may be performed in response to the detection of the user's mobile device 120 within one or more threshold distances from the computing device 100, as previously described.

In one embodiment, the secondary proximity detection devices may be used to effect other power state transitions, for example, the proximity detection module 111 may transition the computing system 100 from a working state to a sleep state in response to the camera 108 detecting that the user is no longer present near the computing system 100. As an additional example, the computing system 100 may be transitioned to the sleep power state if the camera 108 detects no movement for a predetermined period of time.

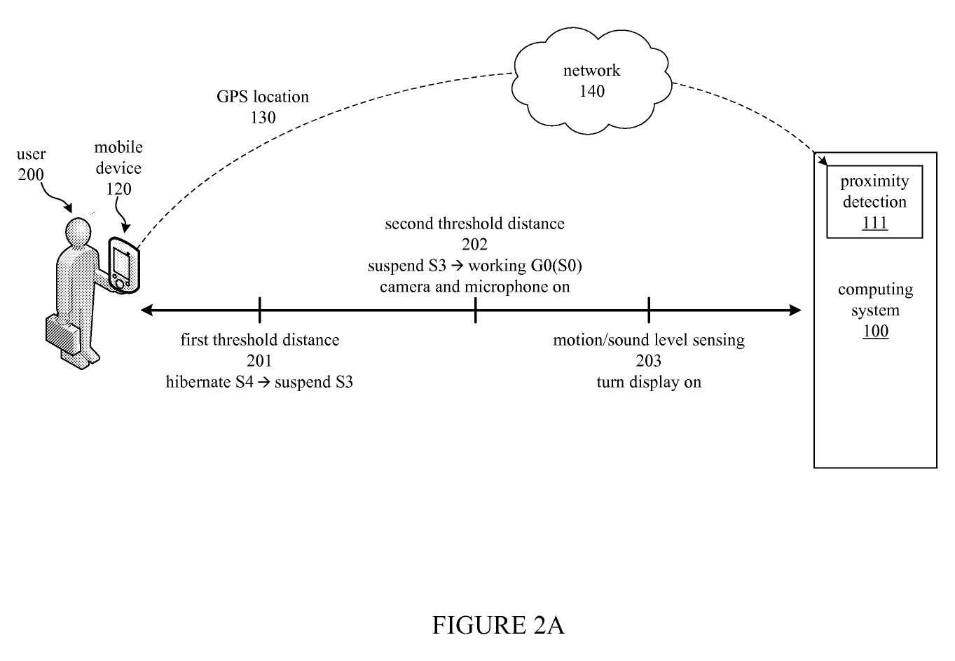

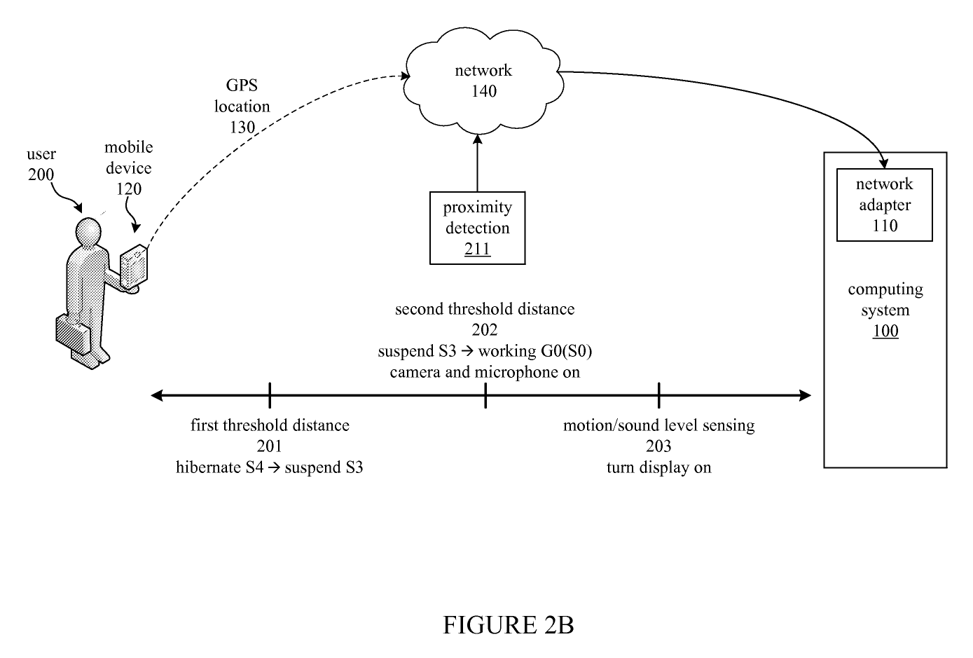

FIG. 2A illustrates multiple thresholds for triggering power state transitions in a computing system 100, according to an embodiment. In FIG. 2A, the computing system 100 includes a proximity detection module 111 that is located within the housing of the computing system 100. The mobile device 120 carried by the user 200 transmits the GPS location 130 of the mobile device 120 over the network 140 to the proximity detection module 111, then the proximity detection module 111 determines whether the mobile device 120 is located within one or more of the thresholds 201, 202, and 203 according to the methods as previously described.

When the proximity detection module 111 determines that the location 130 of the mobile device 120 is less than the first threshold distance 201 away from the computing system 100, the proximity detection module 111 causes the computing system 100 to transition from an S4 hibernate state to an S3 suspend state. When the proximity detection module 111 determines that the location 130 is less than the second threshold distance 202 away from the computing system 100, the proximity detection module 111 causes the computing system 100 to transition from the S3 suspend state to a G0(S0) working state with the display 105 powered off. At this stage, the proximity detection module 111 may activate one or more secondary proximity detection devices, such as the camera 108 and microphone 107. In an alternative embodiment, the secondary proximity detection devices may be activated and controlled by software that is automatically executed when the computing system 100 enters the working state, rather than being activated directly by the proximity detection module 111.

When the secondary proximity detection devices, such as the camera 108 or microphone 107, detect the presence of a user, the proximity detection module 111 changes the power state of the computing system 100 by powering on a display 105 of the computing system 100.

FIG. 2B illustrates multiple thresholds for triggering power state transitions in a computing system 100, according to an embodiment where the proximity detection module 211 is separate from the computing system 100. As illustrated in FIG. 2B, the proximity detection module 211 is located outside of the housing of computing system 100 and is communicatively coupled with the network adapter 110 of the computing system 100 through the network 140. In one embodiment, the proximity detection module 211 may control power states for multiple computing systems such as computing system 100.

In one embodiment, the location of the computing system 100 may be determined by the computing system 100 or a device attached to the computing system, then reported to the proximity detection module 211 through the network 140. Alternatively, the location of the computing system 100 may be entered manually by a user. The location of the computing system 100, whether detected or manually entered, may be stored in a location accessible to the proximity detection module 211.

The proximity detection module 211 receives the GPS location 130 from the mobile device, then compares the location 130 with the stored location of the computing system 100 to determine whether the mobile device 120 is within one or more of the threshold distances 201 or 202 away from the computing system 100. If the proximity detection module 211 determines that the mobile device 120 is located within the first threshold distance 201, the proximity detection module 211 transmits a signal through network 140 to cause the computing system 100 to transition from an S4 hibernate state to an S3 sleep state. If the proximity detection module 211 determines that the mobile device 120 is located within the second threshold distance 202, the proximity detection module 211 transmits a signal through network 140 to cause the computing system 100 to transition from the S3 sleep state to a G0(S0) working state, with the display 105 of the computing system 100 off. In one embodiment, power state transitions for the computing system 100 may be effected using Wake-on-LAN or similar technology.

Upon transitioning to the working state, the computing system may activate one or more secondary proximity detection devices, such as camera 108 and microphone 107. In one embodiment, the secondary proximity detection devices are controlled locally in the computing system 100 to change the power state of the computing system (e.g., by turning on the display 105) in response to detecting the presence of a user near the computing system.

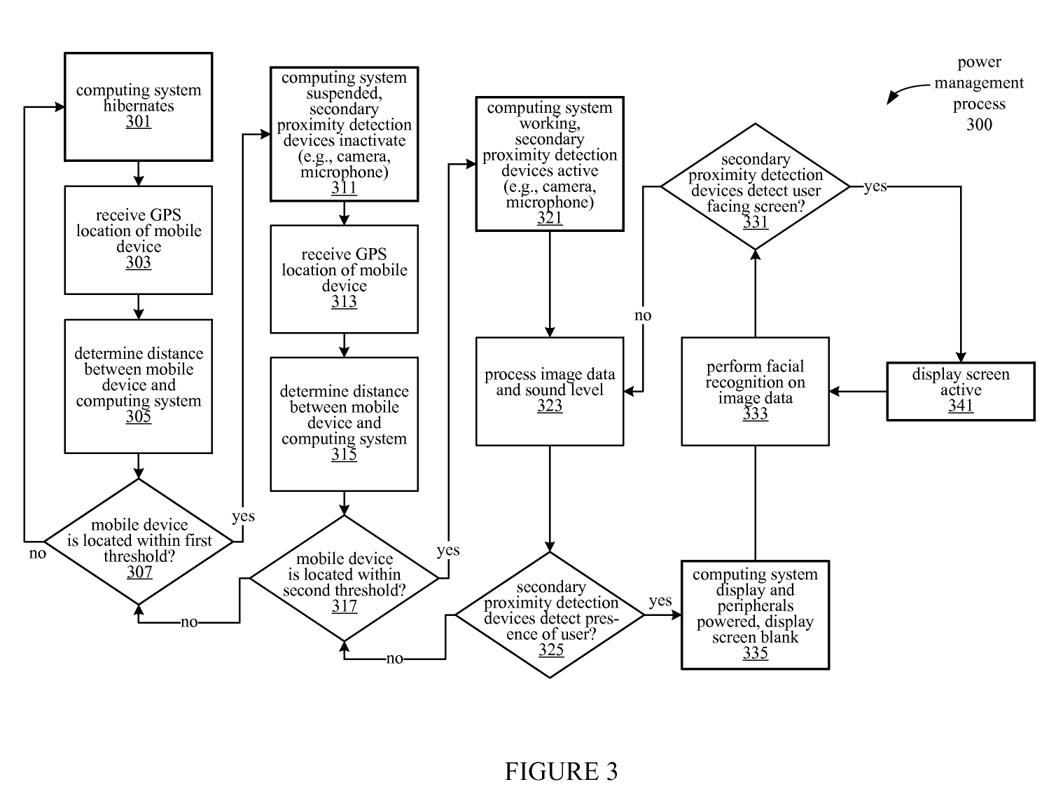

FIG. 3 illustrates a flow diagram of a power management process 300 for controlling power states of a computing system 100 based on external sensors and data indicating the location of a user, according to an embodiment. The operations described in process 300 may be executed by some or all of the proximity detection module 111, computing system 100, and mobile device 120 and their respective components.

Power management process 300 begins with the computing system operating in a hibernate power state, as provided at block 301. In one embodiment, the hibernate power state is an ACPI S4 hibernate power state. From block 301, the process 300 continues at block 303.

At block 303, the proximity detection module 111 determines the location of a mobile device 120 by receiving from the mobile device 120 a GPS location 130 of the mobile device. The mobile device 120 includes a GPS locator 122 that determines the location 130, then an application 121 or other software on mobile device 120 transmits the location 130 to the proximity detection module 111 via network 140 and network adapter 110 of the computing system 100.

At block 305, the proximity detection module 111 determines a distance between the location 130 of the mobile device 120 and a location of a computing system 100. At block 307, the proximity detection module 111 compares the distance calculated at block 305 with a first threshold distance 201 to determine whether the mobile device 120 is located within the first threshold distance 201 from the computing system 100. If, at block 307, the mobile device 120 is not located within the first threshold distance 201, the process 300 continues back to block 301.

At block 301, the computing system 100 remains in the hibernate state. While the mobile device 120 is not detected within the first threshold 201, the process 300 may repeat blocks 301, 303, 305, and 307, to maintain the computing system 100 in the hibernate state, while repeatedly monitoring the location of the mobile device 120 to determine whether the mobile device 120 has crossed the first threshold 201.

If, at block 307, the proximity detection module 111 determines that the mobile device 120 is located within the first threshold 201, the process 300 continues at block 311. At block 311, the proximity detection module 111 causes the computing system to transition to the suspend power state, which consumes more power than the hibernate power state. In one embodiment, the standby power state is an ACPI S3 standby power state. In one embodiment, the proximity detection module 111 causes the computing system 100 to transition between power states via a signal to power controller 109 of the computing system 100. From block 311, the process 300 continues at block 313.

At blocks 313 and 315, the proximity detection module 111 again receives the location 130 of the mobile device 120 and determines the distance between the mobile device 120 and the computing system 100 in similar fashion as the operations in blocks 303 and 305.

The process 300 continues at block 317, where the proximity detection module 111 determines, based on the results of blocks 313 and 315, whether or not the mobile device 120 is located within a second threshold 202. Specifically, the proximity detection module 111 compares the distance between the location of the mobile device 120 and the location of the computing system 100 with the second threshold distance 202. If, at block 317, the mobile device 120 is determined not to be located within the second threshold, the process 300 continues at block 307.

At block 307, the proximity detection module 111 compares the distance determined at block 315 with the first threshold distance 201 to determine if the mobile device 120 is within the first threshold distance 201 from the computing device 100. Thus, the process 300, having previously detected the mobile device at a location within the first threshold distance 201, can subsequently determine whether the mobile device 120 has since moved farther than the first threshold distance 201 away from the computing system 100, and transition the computing system 100 back to the hibernate state accordingly, at block 301.

If the mobile device 120 remains in a position located between the first threshold 201 and the second threshold 202, then the process 300 continues from block 307 to block 311. Thus, while the mobile device 120 remains between the first and second thresholds 201 and 202, the blocks 311, 313, 315, 317, and 307 repeat, keeping the computing system 100 in the suspend power state, with secondary proximity detection devices inactive.

At block 317, if the proximity detection module 111 determines that the mobile device 120 is within the second threshold distance 202 from the computing system 100, the proximity detection module 111 transitions the computing system to a working state, as provided at block 321. In one embodiment, the computing system 100 while operating in the working state may still conserve power by leaving some devices or peripherals unpowered. For example, the display 105 and input devices 102 may remain unpowered. However, select devices or peripherals that function as secondary proximity detection devices are activated, such as camera 108, microphone 107, RFID module 114, and network adapter 110.

At block 323, data from the secondary proximity detection devices is processed. For example, the camera 108 can be used to capture image data and successive frames may be compared to detect movement from a user nearby. The microphone 107 can continuously or periodically record ambient noise to detect an increase in sound level caused by a user nearby. The proximity detection module 111 or software running on computing system 100 can detect the proximity of the user based on whether the camera detects a threshold level of movement, the microphone detects a threshold sound level, the RFID module 114 or network adapter 110 is within range for communicating with the mobile device 120, or a combination of these and/or other factors.

At block 325, proximity detection module 111 or the software operating on the computing system determines whether the presence of a user has been detected by the secondary proximity detection devices. If the presence of the user is not detected by the secondary proximity detection devices, the process 300 returns to block 317. From block 317, the process 300 can transition the computing system 100 back to the sleep or hibernate power states as previously described, depending on whether the mobile device 120 has moved farther than the first or second thresholds 201 and 202 away from the computing system 100.

If, at block 325, the presence of a nearby user is detected by the secondary proximity detection devices, the process 300 continues at block 335. At block 335, the proximity detection module 111 or software operating on the computing system 100 transitions the computing system from the working power state as described in block 321 to a working power state where the peripherals and other devices of the computing system 100 are powered. For example, the power state transition may include powering up the display 105 and input devices 102 and spinning up hard drives.

At block 333, the proximity detection module 111 or software operating on the computing system 100 receives image data from the camera 108 and performs facial recognition on the image data to determine whether the user is facing the display 105 of the computing system 100. In one embodiment, the camera 108 is positioned to face the same direction as the display 105, so that a frontal view of the user's face can be captured when the user is facing the display 105.

At block 331, if the user's face is not detected, then the process 300 continues back to block 325. From block 325, the process 300 can transition the computing system 100 back to the other power states as previously described, depending on whether the presence of the user can still be detected by the secondary proximity detection devices, or mobile device 120 has moved farther than the first or second thresholds 201 and 202 away from the computing system 100.

If, at block 331, the user's face is detected facing the display 105, it can be inferred that the user intends to interact with the computing system 100. Accordingly, the process 300 continues at block 341, where the display screen is activated. Activation of the display screen may include transitioning the screen out of a screen saver or blank screen mode and displaying the working desktop or applications for the computing system 100 on the screen. From block 341, the process 300 may return periodically to block 333 to check that the user is still facing the display 105. In one embodiment, if the user is not determined to be facing the display 105 for more than a predetermined duration, the display 105 is switched to a blank screen or screen saver at block 335.

Depending on the power state in which the computing system 100 is operating, the process 300 tracks the location of the user's mobile device 120 relative to the threshold distances, determines based on secondary proximity detection devices whether the user is nearby, and determines using the camera 108 whether the user is facing the display 105 of the computing system 100. The process 300 then transitions the computing system 100 to different power states accordingly. In alternative embodiments, the thresholds may correspond to different power state transitions; for example, the first threshold 201 may cause the computing system 100 to transition from a suspend power state to a working power state instead of from a hibernate power state to a suspend power state.

Each power state transition as described herein may also represent multiple power state transitions; for example, when transitioning from a hibernate state to a suspend state, the computing system 100 may actually transition from the hibernate state to a working state, then transition from the working state to the suspend state. In such a case, the computing system 100 may automatically transition from the intermediate power state to the target power state without additional input from the user and without an additional determination of the user's location or orientation.

The embodiments described herein may include various operations. These operations may be performed by hardware components, software, firmware, or a combination thereof. As used herein, the term “coupled to” may mean coupled directly or indirectly through one or more intervening components. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Certain embodiments may be implemented as a computer program product that may include instructions stored on a non-transitory computer-readable medium. These instructions may be used to program a general-purpose or special-purpose processor to perform the described operations. A computer-readable medium includes any mechanism for storing or transmitting information in a form (e.g., software, processing application) readable by a machine (e.g., a computer). The non-transitory computer-readable storage medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory, or another type of medium suitable for storing electronic instructions.

Additionally, some embodiments may be practiced in distributed computing environments where the computer-readable medium is stored on and/or executed by more than one computer system. In addition, the information transferred between computer systems may either be pulled or pushed across the transmission medium connecting the computer systems.

Generally, a data structure representing the computing system 100 and/or portions thereof carried on the computer-readable storage medium may be a database or other data structure which can be read by a program and used, directly or indirectly, to fabricate the hardware comprising the computing system 100. For example, the data structure may be a behavioral-level description or register-transfer level (RTL) description of the hardware functionality in a high level design language (HDL) such as Verilog or VHDL. The description may be read by a synthesis tool which may synthesize the description to produce a netlist comprising a list of gates from a synthesis library. The netlist comprises a set of gates which also represent the functionality of the hardware comprising the computing system 100. The netlist may then be placed and routed to produce a data set describing geometric shapes to be applied to masks. The masks may then be used in various semiconductor fabrication steps to produce a semiconductor circuit or circuits corresponding to the computing system 100. Alternatively, the database on the computer-readable storage medium may be the netlist (with or without the synthesis library) or the data set, as desired, or Graphic Data System (GDS) II data.

Although the operations of the method(s) herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

In the foregoing specification, the embodiments have been described with reference to specific exemplary embodiments thereof. It will, however, be evident that various modifications and changes may be made thereto without departing from the broader spirit and scope of the embodiments as set forth in the appended claims. The specification and drawings are, accordingly, to be regarded in an illustrative sense rather than a restrictive sense.

What is claimed is:

1. A method, comprising:
determining a location of a mobile device;
determining a distance between the location of the mobile device and a location of a computing system to determine whether the mobile device is located within a first threshold distance from the computing system; and
in response to determining that the mobile device is located within the first threshold distance from the computing system, transitioning the computing system from a first power state to a second power state.

2. The method of claim 1, wherein determining the location of the mobile device comprises receiving from the mobile device a global positioning system (GPS) location of the mobile device.

3. The method of claim 1, wherein the computing system while operating in the first power state consumes less power than the computing system while operating in the second power state.

4. The method of claim 1, further comprising:
comparing the distance between the location of the mobile device and the location of the computing system with a second threshold distance; and
in response to determining that the mobile device is within the second threshold distance from the computing system, transitioning the computing system from the second power state to the third power state and activating one or more secondary proximity detection devices.

5. The method of claim 4, further comprising, in response to the one or more secondary proximity detection devices detecting proximity of a user, powering up a display of the computing system.

6. The method of claim 4, wherein the first power state is an Advanced Configuration and Power Interface (ACPI) S4 hibernate power state, wherein the second power state is an ACPI S3 standby power state, and wherein the third power state is an ACPI G0(S0) working power state.

7. The method of claim 4, wherein one of the secondary proximity detection devices comprises a camera, and wherein the method further comprises transitioning the computing device from the third power state to a fourth power state based on motion detected by the camera.

8. The method of claim 7, wherein another of the secondary proximity detection devices comprises a microphone, and wherein transitioning the computing device from the third power state to the fourth power state is additionally based on a sound level detected by the microphone.

9. An apparatus, comprising:
a computing system operable in each of at least a first power state and a second power state;
an input configured to receive a location of a mobile device; and
a proximity detection module coupled with the input and with the computing system, wherein the proximity detection module is configured to:
determine a distance between the location of the mobile device and a location of the computing system to determine whether the mobile device is located within a first threshold distance from the computing system, and
in response to determining that the mobile device is within the first threshold distance from the computing system, cause the computing system to transition from the first power state to the second power state.

10. The apparatus of claim 9, wherein the proximity detection module is located within a housing of the computing system.

11. The apparatus of claim 9, further comprising the mobile device, wherein the mobile device further comprises a GPS locator, and wherein the mobile device is configured to transmit a GPS location of the mobile device to the proximity detection module.

12. The apparatus of claim 9, further comprising one or more secondary proximity detection devices, wherein the proximity detection module is configured to transition the computing system from the second power state to a third power state and to activate at least one of the one or more secondary proximity detection devices in response to determining that the mobile device is located within a second threshold distance from the computing system.

13. The apparatus of claim 12, wherein the proximity detection module is further configured to, in response to the one or more secondary proximity detection devices detecting proximity of a user, powering up a display of the computing system, wherein the first power state is an Advanced Configuration and Power Interface (ACPI) S4 hibernate power state, wherein the second power state is an ACPI S3 standby power state, and wherein the third power state is an ACPI G0(S0) working power state.

14. The apparatus of claim 12, wherein the one or more secondary proximity detection devices comprises:
a camera coupled with the proximity detection module; and
a microphone coupled with the proximity detection module, wherein the proximity detection module is further configured to transition the computing device from the third power state to a fourth power state based on motion detected by the camera and based on a sound level detected by the microphone.

15. A non-transitory computer readable medium storing instructions that when executed by a processor cause the processor to perform a method comprising:
determining a location of a mobile device;
determining a distance between the location of the mobile device and a location of a computing system to determine whether the mobile device is located within a first threshold distance from the computing system; and
in response to determining that the mobile device is located within the first threshold distance from the computing system, transitioning the computing system from a first power state to a second power state.

16. The non-transitory computer-readable medium of claim 15, wherein determining the location of the mobile device comprises receiving from the mobile device a global positioning system (GPS) location of the mobile device.

17. The non-transitory computer-readable medium of claim 15, wherein the method further comprises:
comparing the distance between the location of the mobile device and the location of the computing system with a second threshold distance; and
in response to determining that the mobile device is within the second threshold distance from the computing system, transitioning the computing system from the second power state to a third power state and activating one or more secondary proximity detection devices.

18. The non-transitory computer-readable medium of claim 17, wherein the method further comprises, in response to the one or more secondary proximity detection devices detecting proximity of a user, powering up a display of the computing system, wherein the first power state is an Advanced Configuration and Power Interface (ACPI) S4 hibernate power state, wherein the second power state is an ACPI S3 standby power state, and wherein the third power state is an ACPI G0(S0) working power state.

19. The non-transitory computer-readable medium of claim 17, wherein one of the secondary proximity detection devices comprises a camera, and wherein the method further comprises transitioning the computing device from the third power state to a fourth power state based on motion detected by the camera.

20. The non-transitory computer-readable medium of claim 17, wherein one of the secondary proximity detection devices comprises a microphone, and wherein the method further comprises transitioning the computing device from the third power state to a fourth power state based on a sound level detected by the microphone.
